(19) United States
(12) Patent Application Publication
(10) Pub. No.: US 2013/0015301 A1
(43) Pub. Date: Jan. 17, 2013

(54) APPARATIS FOR SECURING AND STABILIZING AN ELEVATED PIPE

(71) Applicant: Radim Zvak, Addison, IL (US)

(72) Inventor: Radim Zvak, Addison, IL (US)

(21) Appl. No.: 13/180,747

(22) Filed: Jul. 12, 2011

(51) Int. Cl. F16L 3/08; B23P 11/00

(52) U.S. Cl. 248/74.1; 29/428

(57) ABSTRACT

An apparatus and method for securing a cylindrical object to a vertical surface in an accurate and stable manner. The apparatus is structured to allow for the proper placement of a precise gradient of the cylindrical object over an extended distance. The apparatus further provides for the support and maintenance of the gradient over an extended period.

### CROSS-REFERENCE TO RELATED APPLICATIONS

NONE

### STATEMENT REGARDING FEDERALLY SPONSORED RESEARCH OR DEVELOPMENT

NONE

### BACKGROUND OF THE INVENTION

### Technical Field

This invention relates generally to an apparatus for the securing of cylindrical items to a vertical or horizontal surface. More particularly, it relates to an apparatus for the securing of piping to the foundation of a structure to allow for and maintaining accurate gradient to allow for the flow of liquids from the structure.

### BACKGROUND

The securing of cylindrical items to a surface with an accurate gradient and also maintaining said gradient has many problems. For example the gradient can be changed over time by many factors from simple stress of the pipe with the weight change as liquids flow through the system or weight exerted if pipe is covered by earth or some other substance. This is a particular problem with respect to drainage systems on modern structures where the drainage pipes are buried in the earth around the structure but need to maintain a proper gradient to allow for the proper flow of water and waste away from the structure preventing backflow.

The industry currently uses methods that frequently cause issues that cause costly repairs the owner of the structure when the gradient changes and a backflow occurs causing loss to property and major excavation to repair the gradient. Currently the industry uses nails and some sort of support weather it is wood blocks or simple the nails alone to maintain the gradient. This system has inherent flaws from the deterioration of the support blocks to the natural settling of the earth that causes the gradient to change. Additionally the use of this method the does not lend itself to an accurate gradient which may not initially cause problems but with the pressures of time may become magnified and manifest issues in the structure.

The objects of the invention therefore are:

Providing an apparatus that allows for an accurate method of installing a cylindrical item with a proper gradient.

Providing an apparatus that secures a cylindrical item to a structure securely.

Providing an apparatus that maintains the proper gradient of a system for an extended period of time.

### SUMMARY OF THE INVENTION

The foregoing objects are accomplished and the shortcomings of the prior art are overcome by the apparatus of this invention which in one embodiment is a holder member in connection with a support member with on or more attachment means in the support member and including a brace member to increase stability and strength. The apparatus is further made from a metal or plastic composition that allows for the long term maintenance of a cylindrical item to a vertical surface. The apparatus also allows for the proper gradient to be installed over an extended area with greater accuracy and to be maintained for a greater period without the loss of integrity.

In an embodiment, the apparatus is produced from powder-coated steal that further extends the durability and stability of the current invention by preventing corrosion and limiting the failure of the apparatus.

In another embodiment, the apparatus includes a locking mechanism where in the cylindrical item is securely inserted into the holder then locked into place to increase overall stability. The most preferred locking mechanism is a simple modification of the holder member wherein its end is curved requiring the cylindrical item to be snapped into the holder member, member mixing chamber and product chamber include a conductivity sensor.

The method of attaching a length of piping to a vertical surface wherein you use the apparatus of this invention wherein said apparatus is secured to the vertical surface through the attachment member. Once the apparatus in attached to the vertical surface a length of pipe is fitted into the apparatus. Once that is secure then the next apparatus is placed a predetermined length from the previous apparatus at the predetermined gradient and attached to the vertical surface through the attachment member then another length of pipe is fitted to the apparatus this process is then repeated until the entire length of pipe is attached to the vertical surface at the proper gradient.

These and still other objects and advantages of the invention will be apparent from the description which follows. In the detailed description below a preferred embodiment of the invention will be described in reference to the full scope of the invention. Rather, the invention may be employed in other embodiments.

### BRIEF DESCRIPTION OF DRAWING

FIG. 1 is a diagrammatic side view of one embodiment apparatus of this invention.

FIG. 2 is a diagrammatic side view of an embodiment apparatus of this invention including an optional embodiment of the locking member.

### DESCRIPTION OF THE PREFERRED EMBODIMENT

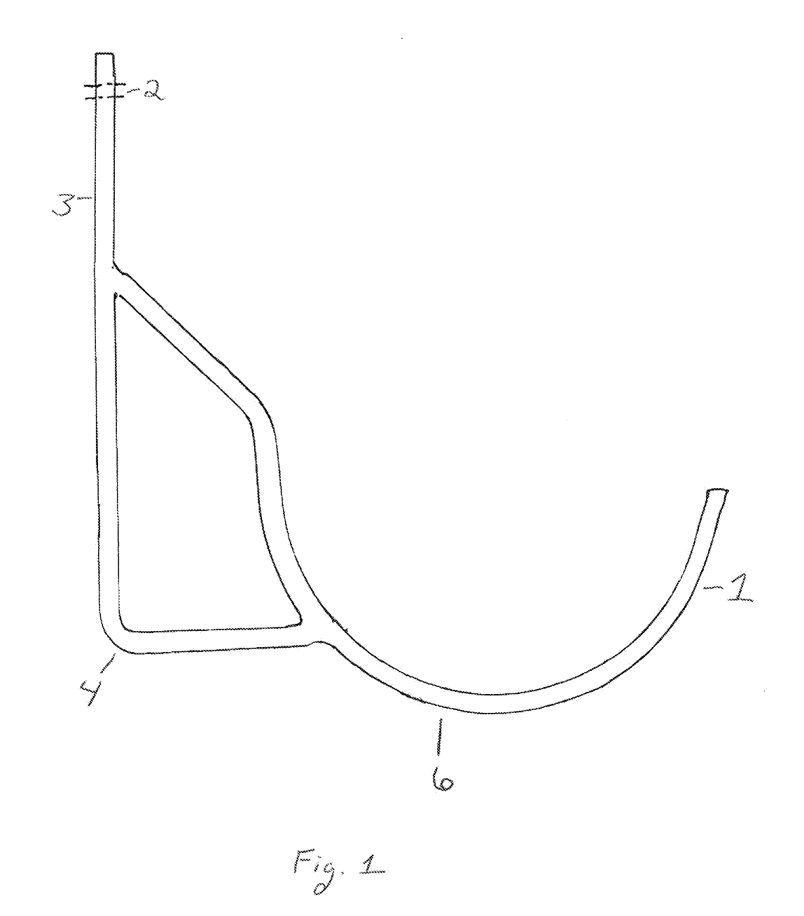

FIG. 1 exemplifies a side view of one embodiment of the claimed apparatus 6. The apparatus 6 which is used for securing a cylindrical item to a vertical surface comprising a holder member 1, a support member 3, one or more attachment members 2 and a brace member 4.

The holder member 1 of the claimed apparatus 6 is in one embodiment semi cylindrical shape that allows the cylindrical item to fit in securely and prevent movement. The apparatus 6 further including one or more attachment member 2 located in the upper section of the support member 3.

The embodiment of the apparatus 6 as wherein the brace member 4 forms an approximate 90 degree angle in connection with the support member 3 at one end and the holder member 1 at the opposite end. Further the apparatus 6 may also include wherein the support member 3 and the brace member 4 are continuous and are connected to the holder member 1.

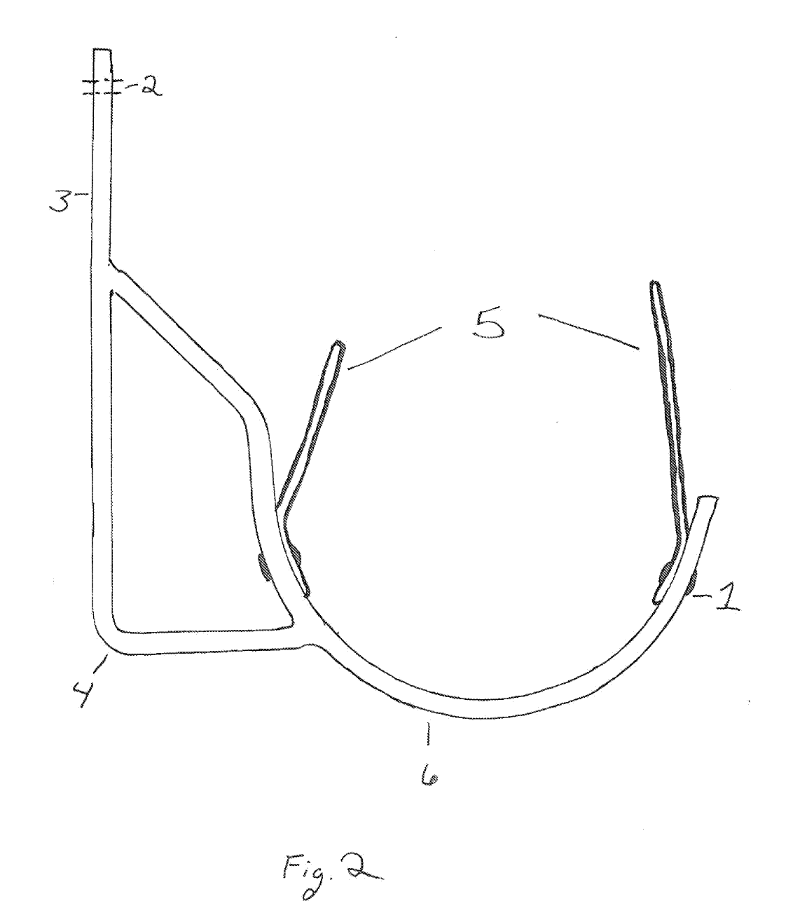

The apparatus 6 as shown in FIGS. 1 and 2 that in one embodiment maybe fabricated from a metal composition which can be additionally a powder coated metal. The apparatus 6 as shown in FIGS. 1 and 2 that in an alternative embodiment may be fabricated from plastic composition.

FIG. 2 exemplifies an additional embodiment of the claimed apparatus 6 in a side view. This embodiment of the claimed apparatus 6 for securing a cylindrical item to a vertical surface comprising a holder member 1, a support member 3, one or more attachment members 2, a brace member 4 and optionally an embodiment of a locking member 5 attached to the holder member 1.

The claimed invention further including a method of attaching a length of piping to a vertical surface wherein you use the claimed apparatus 6 secured to the vertical surface through the attachment member 2 and the length of pipe is fitted into the holder member 1 of the claimed apparatus 6 then the next apparatus 6 is placed a predetermined length from the previous apparatus 6 at the predetermined gradient and attached to the vertical surface through the attachment member 2 and the length of pipe is fitted into the holder member 1 of the claimed apparatus 6, aforementioned process is repeated until the entire length of pipe is attached to the vertical surface at the proper gradient. The method further including a locking member 5 attached to the holder member 1 and securing the length of pipe to the holder member 1.

While the principles of the invention have been shown and described in connection with a few preferred embodiments, it is to be understood clearly that such embodiments are by way of example and are not limiting.

1. An apparatus for securing a cylindrical item to a vertical surface comprising:
a holder member;
one or more attachment members;
a support member; and
a brace member.

2. The apparatus as defined in claim 1 wherein the holder member is semi cylindrical.

3. The apparatus as defined in claim 2 wherein one or more attachment member(s) is in the upper section of the support member.

4. The apparatus as defined in claim 3 wherein the brace member forms an approximate 90 degree angle in connection with the support member at one end and the holder member at the opposite end.

5. The apparatus as defined in claim 2 wherein the support member and the brace member are continuous and are connected to the holder member.

6. The apparatus as defined in claim 2 wherein the apparatus is fabricated from a metal composition.

7. The apparatus as defined in claim 6 wherein the metal composition is a powder coated steel.

8. The apparatus as defined in claim 2 wherein the apparatus is fabricated from a plastic composition.

9. The apparatus as defined in claim 2 further including a locking member connected to the holder member.

10. A method of attaching a length of piping to a vertical surface wherein you use the apparatus of claim 2 wherein said apparatus is secured to the vertical surface through the attachment member and the length of pipe is fitted into the holder member of the apparatus then the next apparatus is placed a predetermined length from the previous apparatus at the predetermined gradient and attached to the vertical surface through the attachment member and the length of pipe is fitted into the holder member of the apparatus, aforementioned process is repeated until the entire length of pipe is attached to the vertical surface at the proper gradient.

11. The method of claim 10 wherein the apparatus includes a locking member which further secures the length of pipe to the holder member.
